(19) United States
(12) Patent Application Publication
(10) Pub. No.: US 2017/0347822 A1
(43) Pub. Date: Dec. 7, 2017

(54) Jorge Rene Patino, Greenacres, Florida: Use of stick deodorant technology as a container for spreading butter, peanut butter, jelly, jam, cream cheese and other spreadable food products

(71) Applicant: Jorge Rene Patino, Greenacres, FL (US)

(72) Inventor: Jorge Rene Patino, Greenacres, FL (US)

(21) Appl. No.: 15/175,993

(22) Filed: Jun. 7, 2016

(51) Int. Cl. A47J 9/00

(52) U.S. Cl. CPC A47J 9/001

(57) ABSTRACT

Use of stick deodorant technology as a container for spreading butter, peanut butter, jelly, jam, cream cheese and other spreadable food products.

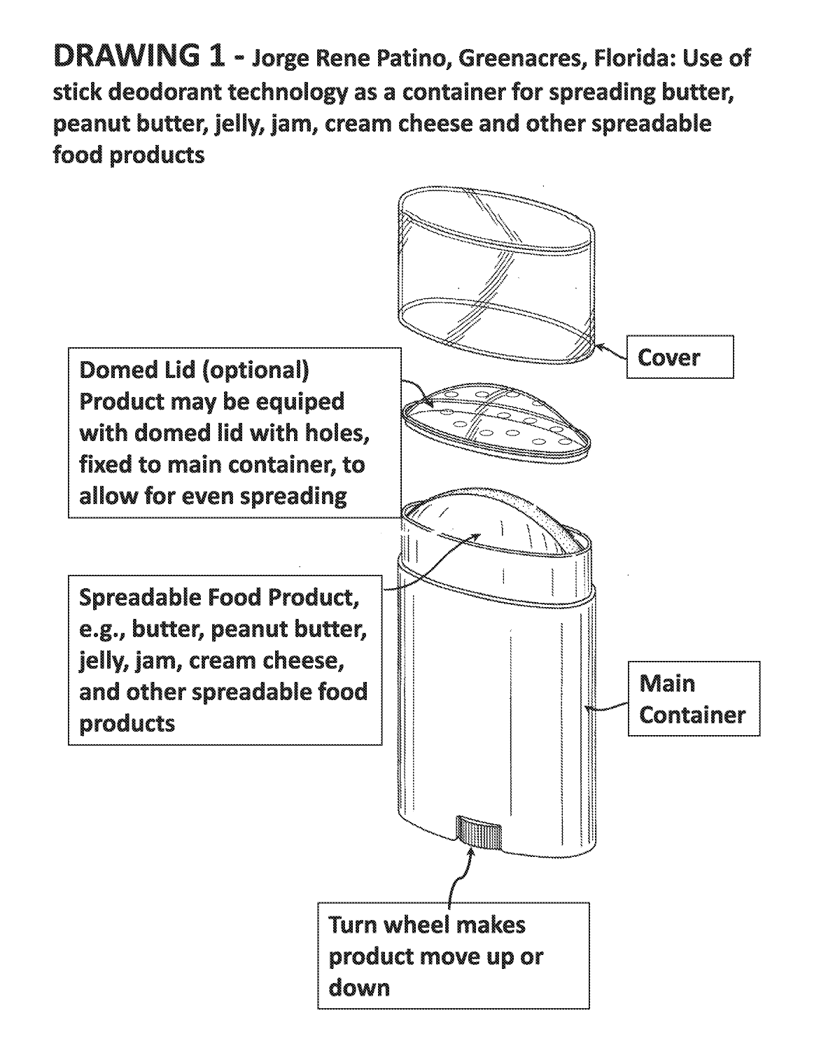

### CROSS-REFERENCE TO RELATED APPLICATION

None.

### BACKGROUND OF THE INVENTION

The use of stick deodorant technology shown in Drawing 1 for the application of antiperspirant and deodorant products is well known in personal care products. The container or vessel used to apply these products is typically comprised of a main container equipped with (1) a turn wheel that makes the product go up and down by rotating an interior screw-like rod, (2) a domed lid or seal, and (3) a cover.

Spreading butter on bread toast or bread, corn on the cob, pancakes, waffles, or other food products can be tedious, cumbersome, and time-consuming for children, elder adults, people with disabilities, and the average person using conventional utensils such as knifes and spoons. The use of stick deodorant technology as a container for spreading and dispensing butter and other spreadable food products would make this process fast, simple, and clean.

This method of applying spreadable food products was first conceived by its inventor, Jorge R. Patino, several years ago and attempted successfully on Apr. 17, 2016 to spread soft butter on toasted bread. (A video recording is available upon request.) The aforementioned experiment did not use a domed lid with holes. Based on the results of the experiment, it is stipulated that the method would be successful to spread peanut butter, jelly, jam, cream cheese, and other spreadable food products in addition to butter. It is also stipulated that the use of an optional fixed domed lid with holes or perforations would allow for more even application of some of the spreadable food products.

### DETAILED DESCRIPTION OF THE INVENTION

This invention utilizes stick deodorant technology (shown in Drawing 1) to containerize and apply, spread, or dispense butter, peanut butter, jelly, jam, cream cheese, and other spreadable food products onto bread toast or bread, fresh baked bread, corn on the cob, pancakes, waffles and other food products. The container or vessel used to apply these products (shown in Drawing 1) would typically be comprised of a main container equipped with (1) a turn wheel that makes the product go up and down by rotating an interior screw-like rod, (2) a domed lid or seal, and (3) a cover.

### BRIEF DESCRIPTION OF DRAWINGS

Drawing 1 is an exploded view of the typical deodorant stick technology that would be used as a container for spreading butter, peanut butter, jelly, jam, cream cheese and other spreadable food products.

1. Use of stick deodorant technology as a container for spreading butter, peanut butter, jelly, jam, cream cheese and other spreadable food products.
